(19) United States
(12) Patent Application Publication
(10) Pub. No.: US 2004/0096059 A1
(43) Pub. Date: May 20, 2004

(54) Encryption apparatus with parallel Data Encryption Standard (DES) structure

(75) Inventor: Kyung-Duck Seo, Yongin-shi (KR)

Correspondence Address: Frank Chau, F. CHAU & ASSOCIATES, LLP, Suite 501, 1900 Hempstead Turnpike, East Meadow, NY, 11554, US

(73) Assignee: Samsung Electronics Co., Ltd.

(21) Appl. No.: 10/706,829

(22) Filed: Nov. 12, 2003

(30) Foreign Application Priority Data
Nov. 12, 2002 (KR) 2002-069946

(51) Int. Cl. H04K 1/00

(52) U.S. Cl. 380/28

(57) ABSTRACT

An encryption apparatus comprises first and second N-round DES devices and first and second input circuits. The first N-round DES device cryptographically converts a digital input data block into a first digital output data block nonlinearly, based on an input of a set of encryption keys. The first input means receives and inverts the digital input data block. The second input means receives and inverts the set of encryption keys. The second N-round DES device cryptographically converts the inverted digital input data block into a second digital output data block nonlinearly, based on an input of the inverted encryption keys. The first and second N-round DES devices perform a cryptographic conversion process at the same.

### BACKGROUND OF THE INVENTION

1. FIELD OF THE INVENTION:

The present invention relates to data communication, and more particularly to an apparatus for encrypting and decrypting a digital data block.

2. DISCUSSION OF RELATED ART:

The Data Encryption Standard (DES) promulgated by the National Bureau of Standards in, FIPS publication 46, Jan. 15, 1977, describes an algorithm for converting a digital input block into a digital output block. Such an algorithm is generally referred to as a block cipher. The DES algorithm is used for encrypting (enciphering) and decrypting (deciphering) binary coded information. Encrypting converts intelligible data, referred to as plaintext, into an unintelligible form, referred to as ciphertext. Decrypting the ciphertext converts the data back to the intelligible form. In an electronic code book mode, DES is used to encrypt 64 bit blocks of plaintext into corresponding 64 bit blocks of ciphertext. In this mode, the encryption uses keys that are derived from a 64-bit key.

The DES algorithm is used for communication between, for example, a card reader and a smart card. As a data processing system, the smart card securely stores information. If data in the smart card is issued to an unauthorized entity, the owner of the data or a system manager charged with securing data may suffer considerable damage. Unauthorized access of a smart card is called “tampering”. Tampering techniques can be divided into four attack techniques, including microprobing, software-based, eavesdropping, and fault generation. It is possible to obtain information stored in a card memory and key values of an applied encryption algorithm by tampering with a smart card.

The microprobing techniques can be used to access a chip surface directly. Software attack techniques use a communication interface of a processor and exploit security vulnerabilities found in the protocols, cryptographic algorithms, or their implementation. The eavesdropping techniques monitor, with high time resolution, analog characteristics of all supply and interface connections and any other electromagnetic radiation produced by a processor. The fault generation techniques use abnormal environment conditions to generate malfunctions in a processor that provide additional access. All microprobing techniques are invasive attacks. They can require hours or weeks in a specialized laboratory and in the process they destroy the packaging. Software attacks, eavesdropping, and fault generation techniques are non-invasive attacks.

The non-invasive attack techniques, or side channel analysis techniques, determine key values of an encryption algorithm (or DES algorithm) using a timing difference or power consumption (or a consumed current pattern) according to an operation of a smart card. The side channel analysis techniques can be divided into simple power analysis (SPA) and differential power analysis (DPA). The SPA techniques are used to extract key values by analyzing a power measured when an encryption algorithm is carried out. The DPA techniques are used to extract key values introducing statistical and error-correction notions to the SPA techniques.

A consumed current pattern generated when data related to key values of the DES algorithm is processed, generally, shows a minute difference according to whether a data bit to be processed is “1” or “0”. Accordingly, by sorting current patterns showing the minute difference, it is possible to find key values through a difference between a current pattern of a data bit “1” and a current pattern of a data bit “0”.

In conclusion, an improved DES algorithm is needed that can prevent a difference between current patterns of data bits “1” and “0” from being exposed by DPA techniques.

### SUMMARY OF THE INVENTION

It is therefore an object of the invention to provide an encryption apparatus resistant to a side channel analysis.

An encryption apparatus resistant to side channel analysis comprises a first N-round DES device for cryptographically converting a digital input data block into a first digital output data block nonlinearly, based on an input of a set of encryption keys; a first input means for receiving and inverting the digital input data block; a second input means for receiving and inverting the set of encryption keys; and a second N-round DES device for cryptographically converting the inverted digital input data block into a second digital output data block nonlinearly, based on an input of the inverted set of encryption keys. The first and second N-round DES devices perform a substantially simultaneous cryptographic conversion process. The first and second N-round DES devices perform a cryptographic conversion process according to a DES algorithm, respectively.

### BRIEF DESCRIPTION OF THE DRAWINGS

A more complete appreciation of the present invention, and many of the attendant advantages thereof, will become readily apparent as the same becomes better understood by reference to the following detailed description when considered in conjunction with the accompanying drawings in which like reference symbols indicate the same or similar components, wherein:

FIG. 1 shows an encryption apparatus according to a preferred embodiment of the present invention;

FIG. 2 shows an encryption block illustrated in FIG. 1 according to a preferred embodiment of the present invention;

FIG. 3 shows a block diagram of an encryption block illustrated in FIG. 1 according to an embodiment of the present invention;

FIG. 4 shows a cipher function illustrated in FIG. 3; and

FIG. 5 shows permutation schedules of S boxes illustrated in FIG. 4.

### DETAILED DESCRIPTION OF PREFERRED EMBODIMENTS

The invention will be more fully described with reference to the attached drawings.

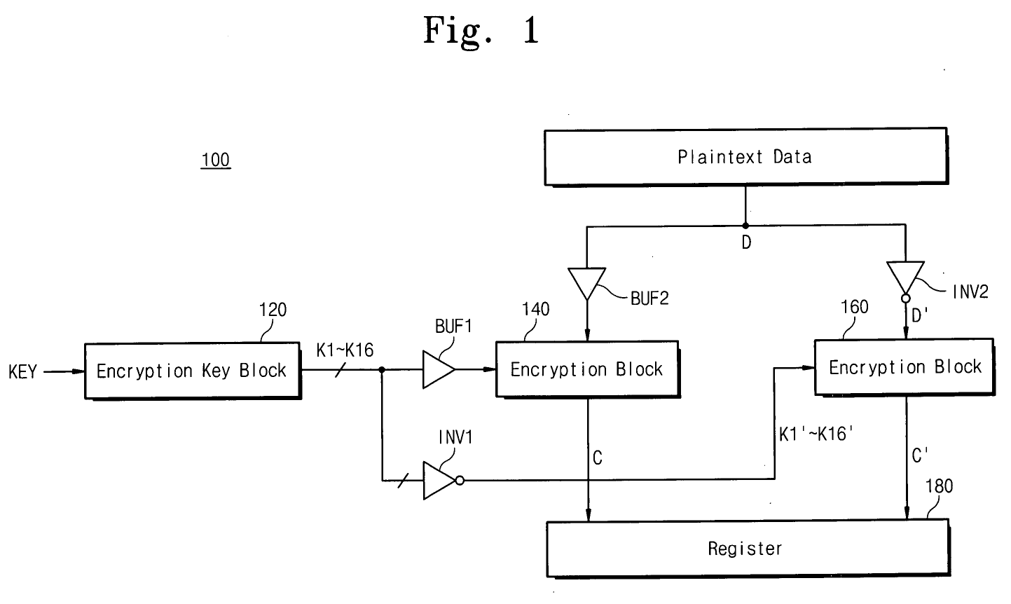

FIG. 1 shows an encryption apparatus according to a preferred embodiment of the present invention. Referring to FIG. 1, an encryption apparatus 100 of the present invention scrambles a digital input data block or plaintext data according to a 64-bit key. The plaintext data is 64-bit data. The encryption apparatus 100 comprises an encryption key block 120, first and second encryption blocks 140 and 160, a register 180, buffers BUF1 and BUF2, and inverters INV1 and INV2.

As illustrated in FIG. 1, the encryption key block 120 receives a 64-bit key KEY and generates a plurality of 48-bit keys K1-K16 according to a permutation method, which will be described below. The encryption keys K1-K16 are transferred to the first encryption block 140 through the buffer BUF1 and to the second encryption block 160 through the inverter INV1. As understood from the above description, the first encryption block 140 performs a cryptographic conversion process using the encryption keys K1-K16 from the encryption key block 120 without modification, while the second encryption block 160 performs a cryptographic conversion process using complement encryption keys K1′-K16′ obtained by taking a 1' complement to the encryption keys K1-K16 from the encryption key block 120. As a 64-bit data block, a digital input data block D is transferred to the first encryption block 140 via the buffer BUF2 and to the second encryption block 160 via the inverter INV2, respectively. The first encryption block 140 scrambles the digital input data block D from the buffer BUF2 in response to the encryption keys K1-K16, while the second encryption block 160 scrambles a data block D′ inverted via the inverter INV2 in response to the complement encryption keys K1′-K16′. The inverted data block D′ is called a complement data block. Encrypted data blocks C and C′ from the encryption blocks 140 and 160 are stored in the register 180. One of the encrypted data blocks C and C′ will be used as an actual encryption data block.

In this embodiment, each of the encryption blocks 140 and 160 performs encryption/decryption operations according to a DES algorithm. In this capacity, the encryption blocks 140 and 160 are referred to as DES devices. Although one buffer BUF1 and one inverter INV1 are illustrated in FIG. 1, it is obvious that buffers and inverters corresponding to each encryption key are used. Likewise, although one buffer BUF2 and one inverter INV2 are illustrated in FIG. 1, it is obvious that buffers and inverters corresponding to each digital input data block are used.

With the above description, the present encryption apparatus 100 is designed to encipher and decipher each digital input data block using a DES algorithm. The encryption apparatus using the DES algorithm enciphers 64-bit data according to a 64-bit key (or an encryption value). Deciphering can be accomplished by using the same key as that used to encipher. In particular, the present encryption apparatus 100, as illustrated in FIG. 1, comprises two encryption blocks 140 and 160 (or DES devices), which individually and simultaneously enciphers a digital input data block (or plaintext data). One of the encryption blocks performs a cryptographic conversion process using encryption values K1-K16 and a data block D without modification, while the other encryption block performs a cryptographic conversion process using complement encryption values K1′-K16′ and a complement data block D′. This means that a data bit “0” or “1” is processed in one encryption block while a data bit “1” or “0” is processed in the other encryption block. By this parallel encryption method, it is difficult to determine key values using current patterns generated when a data block is enciphered.

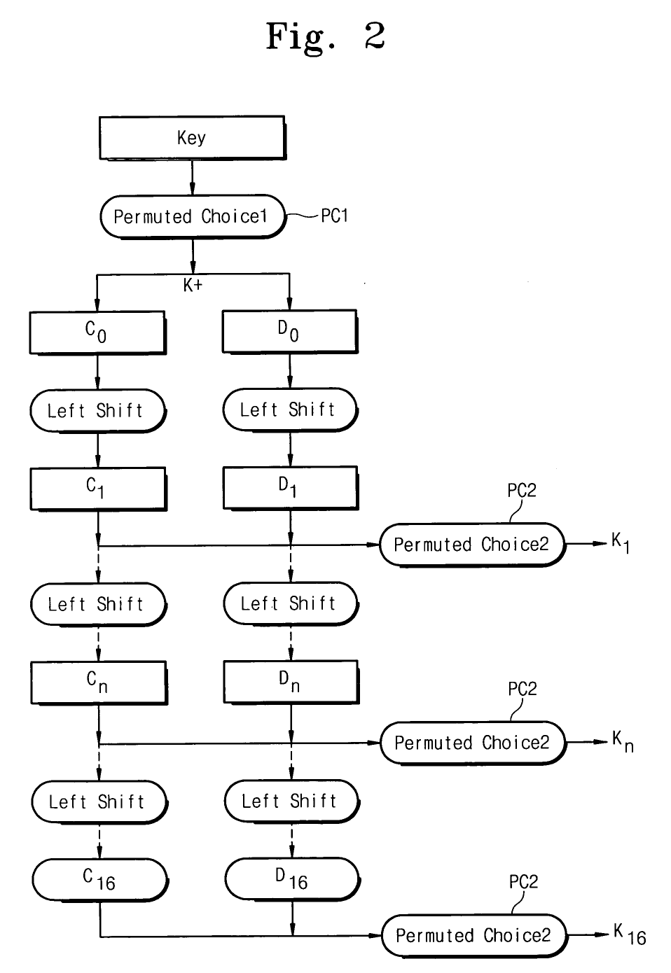

FIG. 2 shows an encryption block illustrated in FIG. 1 according to a preferred embodiment of the present invention. A key K comprises 64 bits. 56 bits of the key K are used by an algorithm. A 64-bit key K is permuted to a 54-bit key K+ according to Table 1, PC-1.

TABLE 1

| | | | | | | |
|---|---|---|---|---|---|---|
| 57 | 49 | 41 | 33 | 25 | 17 | 9 |
| 1 | 58 | 50 | 42 | 34 | 26 | 18 |
| 10 | 2 | 59 | 51 | 43 | 35 | 27 |
| 19 | 1 | 3 | 60 | 52 | 44 | 36 |
| 63 | 55 | 47 | 39 | 31 | 23 | 15 |
| 7 | 62 | 54 | 46 | 38 | 30 | 22 |
| 14 | 6 | 61 | 53 | 45 | 37 | 29 |
| 21 | 13 | 5 | 28 | 20 | 12 | 4 |

Since the first entry in the table is “57”, this means that the 57^{th} bit of the original key K becomes the first bit of the permuted key K+. The 49^{th} bit of the original key becomes the second bit of the permuted key K+. The 4^{th} bit of the original key is the last bit of the permuted key K+. Note, only 56 bits of the original key appear in the permuted key K+. For example, from the original 64-bit key:

K=00010011 00110100 01010111 01111001 10011011 10111100 11011111 1110001

there is obtained the 56-bit permuted key:

K+=1111000 0110011 0010101 0101111 0101010 1011001 1001111 0001111

This key is split into left and right halves, C0 and D0, where each half has 28 bits. For example, from the permuted key K+, there are obtained:

C0=1111000 0110011 0010101 0101111

D0=0101010 1011001 1001111 0001111

With C0 and D0 defined, there are created sixteen blocks Cn and Dn, where 1<=n<=16. Each pair of blocks Cn and Dn is formed from the previous pair Cn-1 and Dn-1, respectively, for n=1, 2, . . . , 16, using the following schedule, Table 2, of “left shifts” preformed on the previous block. To do a left shift, each bit is moved one place to the left, except for the first bit, which is cycled to the end of the block.

TABLE 2

| | | | | | | | | | | | | | | | | |
|---|---|---|---|---|---|---|---|---|---|---|---|---|---|---|---|---|
| Iteration | 1 | 2 | 3 | 4 | 5 | 6 | 7 | 8 | 9 | 10 | 11 | 12 | 13 | 14 | 15 | 16 |
| number | | | | | | | | | | | | | | | | |
| number | 1 | 1 | 2 | 2 | 2 | 2 | 2 | 2 | 1 | 2 | 2 | 2 | 2 | 2 | 2 | 1 |
| of left shifts | | | | | | | | | | | | | | | | |

This means, for example, according to the schedule shown in Table 2 that C3 and D3 are obtained from C2 and D2, respectively, by two left shifts, and C16 and D16 are obtained from C15 and D15, respectively, by one left shift. In all cases, by a single left shift is meant a rotation of the bits one place to the left, so that after one left shift the bits of the 28 positions are the bits that were previously in positions 2, 3, . . . , 28, 1.

The keys Kn are determined, where 1<=n<=16, by applying the following tion table, Table 3, to each of the concatenated pairs CnDn. Each pair has 56 PC-2 only uses 48 of these.

TABLE 3

| | | | | | |
|---|---|---|---|---|---|
| 14 | 17 | 11 | 24 | 1 | 5 |
| 3 | 28 | 15 | 6 | 21 | 10 |
| 23 | 19 | 12 | 4 | 26 | 8 |
| 16 | 7 | 27 | 20 | 13 | 2 |
| 41 | 52 | 31 | 37 | 47 | 55 |
| 30 | 40 | 51 | 45 | 33 | 48 |
| 44 | 49 | 39 | 56 | 34 | 53 |
| 46 | 42 | 50 | 36 | 29 | 32 |

Therefore, the first bit of Kn is the 14^{th} bit of CnDn, the second bit is the 17^{th} bit of CnDn, and so on, ending with the 48^{th} bit of Kn being the 32^{nd} bit of CnDn. For the first key, C1D1 becomes “1110000 1100110 0101010 1011111 1010101 0110011 0011110 0011110”. By applying the C1D1 block to the PC-2 block, K1 becomes “000110 110000 001011 101111 111111 000111 000001 110010”. The other keys K2-K16 can be obtained from corresponding blocks C2D2-C16D16 according to the above manner, respectively. The sixteen 48-bit keys K1-K16 are transferred to the first encryption block 140 through the first buffer BUF1 and to the second encryption block 160 through the inverter INV1, respectively.

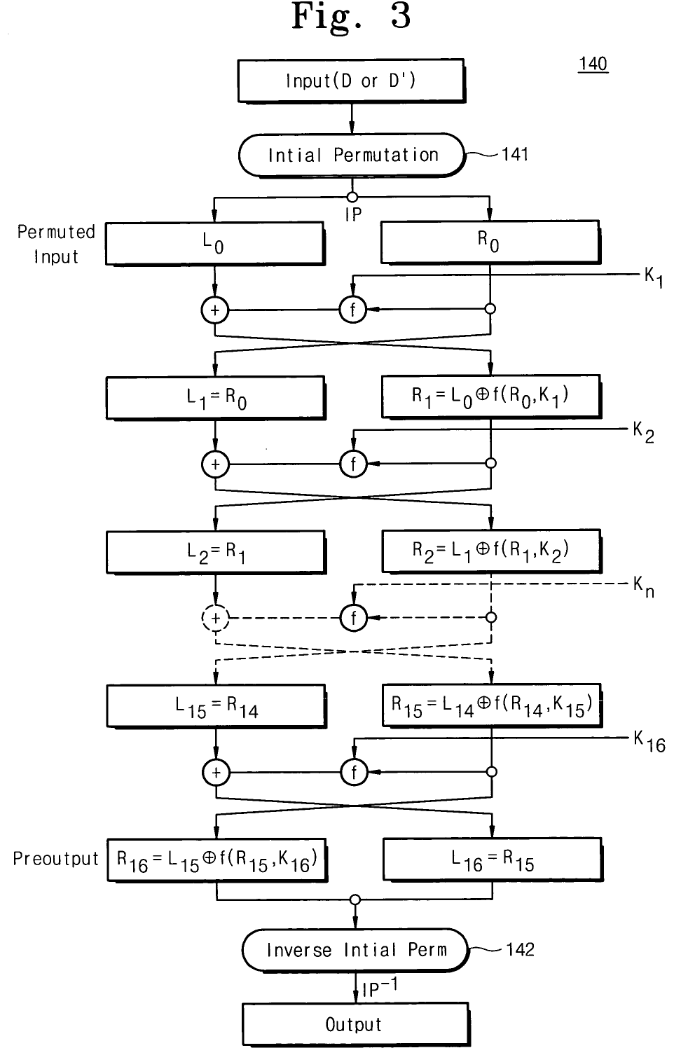

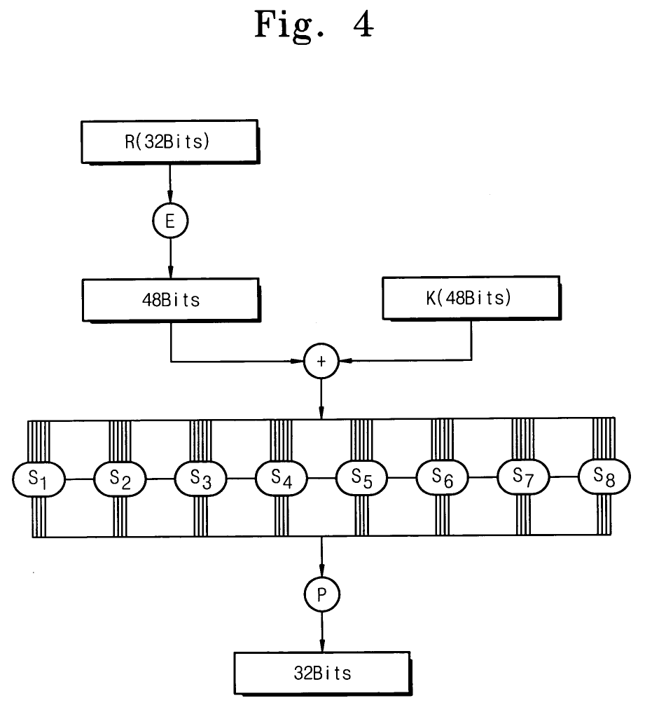

FIG. 3 shows a block diagram of an encryption block illustrated in FIG. 1. FIG. 4 shows a cipher function illustrated in FIG. 3. While encryption block 140 is illustrated in FIG. 3, encryption block 160 is also configured as illustrated in FIG. 3. The encryption block 140 comprises an initial permutation unit 141, an inverse initial permutation unit 142, and a plurality of rounds, for example, 16 rounds. Each round is formed of a cipher function f and XOR units +.

Referring to FIG. 3, 64-bit plaintext data D is transferred to a buffer BUF2 illustrated in FIG. 1, and a bit order of the 64-bit plaintext is permuted by the initial permutation unit 141. That is, the bits of the plaintext are rearranged according to Table 4, where the entries in the table show the new arrangement of the bits from their initial order. The 58^{th} bit of the plaintext D becomes the first bit of a permuted plaintext IP. The 50^{th} bit of the plaintext D becomes the second bit of the permuted plaintext IP. The 7^{th} bit of the plaintext D becomes the last bit of the permuted plaintext IP.

TABLE 4

| | | | | | | | |
|---|---|---|---|---|---|---|---|
| 58 | 50 | 42 | 34 | 26 | 18 | 10 | 2 |
| 60 | 52 | 44 | 36 | 28 | 20 | 12 | 4 |
| 62 | 54 | 46 | 38 | 30 | 22 | 14 | 6 |
| 64 | 56 | 48 | 40 | 32 | 24 | 16 | 8 |
| 57 | 49 | 41 | 33 | 25 | 17 | 9 | 1 |
| 59 | 51 | 43 | 35 | 27 | 19 | 11 | 3 |
| 61 | 53 | 45 | 37 | 29 | 21 | 13 | 5 |
| 63 | 55 | 47 | 39 | 31 | 23 | 15 | 7 |

By applying the initial permutation to the plaintext block D, given previously, there are obtained M and IP:

M=0000 0001 0010 0011 0100 0101 0110 0111 1000 1001 1010 1011 1100 1101 1110 1111

IP=1100 1100 0000 0000 1100 1100 1111 1111 111110000 1010 1010 1111 0000 1010 1010

Here, the 58^{th} bit of the plaintext D is “1”, which becomes the first bit of IP. The 50^{th} bit of D is “1”, which becomes the second bit of IP. The 7^{th} bit of D is “0”, which becomes the last bit of IP.

Next, the permuted block IP is divided into a left half L0 of 32 bits and a right half R0 of 32 bits. For example, from the permuted block IP, there are obtained L0 and R0:

L0=1100 1100 0000 0000 1100 1100 1111 1111

R0=1111 0000 1010 1010 1111 0000 1010 1010

To produce a block of 32 bits, it proceeds through 16 iterations, for 1<=n<=16, using a function f that operates on two blocks: a data block of 32 bits and a key Kn of 48 bits. Let + denote XOR addition, (bit-by-bit addition modulo 2). Then, for n going from 1 to 16 there is determined the following:

Ln=Rn-1

Rn=Ln-1+f(Rn-1,Kn)

This results in a final block, for n=16, of L16R16. That is, in each iteration, it takes the right 32 bits of the previous result and makes them the left 32 bits of the current step. The right 32 bits in the current step are the left 32 bits of the previous step XORed with the calculation f. For example, for n=1,

K1=000110 110000 001011 101111 111111 000111 000001 110010

L1=R0=1111 0000 1010 1010 1111 0000 1010 1010

R1=L0+f(R0,K1)

To determine f, each block Rn-1 is first expanded from 32 bits to 48 bits. This is done by using the selection table, Table 5, that repeats some of the bits in Rn-1. The use of this selection table is called the function E. Thus E(Rn-1) has a 32-bit input block and a 48-bit output block.

Let E be such that the 48 bits of its output, written as 8 blocks of 6 bits each, are obtained by selecting the bits in its inputs in order according to the following table.

TABLE 5

| | | | | | |
|---|---|---|---|---|---|
| 32 | 1 | 2 | 3 | 4 | 5 |
| 4 | 5 | 6 | 7 | 8 | 9 |
| 8 | 9 | 10 | 11 | 12 | 13 |
| 12 | 13 | 14 | 15 | 16 | 17 |
| 16 | 17 | 18 | 19 | 20 | 21 |
| 20 | 21 | 22 | 23 | 24 | 25 |
| 24 | 25 | 26 | 27 | 28 | 29 |
| 28 | 29 | 30 | 31 | 32 | 1 |

Thus, the first three bits of E(Rn-1) are the bits in positions 32, 1 and 2 of Rn-1 while the last 2 bits of E(Rn-1) are the bits in positions 32 and 1. For example, E(R0) is determined from R0 as follows:

R0=1111 0000 1010 1010 1111 0000 1010 1010

E(R0)=011110 100001 010101 010101 011110 100001 010101 010101

Note that each block of 4 original bits has been expanded to a block of 6 output bits.

In the determination of f, as illustrated in FIG. 4, the output E(Rn-1) is XORed with the key Kn. This result can be expressed by Kn+E(Rn-1).

For example, for K1, E(R0),

K1=000110 110000 001011 101111 111111 000111 000001

E(R0)=011110 100001 010101 010101 011110 100001 010101 010101

K1+E(R0)=011000 010001 011110 111010 100001 100110 010100 100111

As a XORed result Kn+E(Rn-1), 48 bits are divided into eight groups of six bits. Bits of each group are used as addresses in tables called “S boxes”. Located at that address will be a 4-bit number. This 4-bit number will replace the original 6 bits. The net result is that the eight groups of 6 bits are transformed into eight groups of 4 bits (the 4-bit outputs from the S boxes) for 32 bits total.

There is written the previous result, which is 48 bits, in the form:

Kn+E(Rn-1)=B1B2B3B4B5B6B7B8,

where each Bi (i=1-8) is a group of six bits. Now, there is determined:

Si (B1)S2(B2)S3(B3)S4(B4)S5(B5)S6(B6)S7(B7)S8(B8),

where Si(Bi) refers to the output of the i-th S box.

To repeat, each of the functions S1, S2, . . . , S8, takes a 6-bit block as input and yields a 4-bit block as output. Table 6 is used to determine SI as follows.

TABLE 6

| | C0 | C1 | C2 | C3 | C4 | C5 | C6 | C7 | C8 | C9 | C10 | C11 | C12 | C13 | C14 | C15 |
|---|---|---|---|---|---|---|---|---|---|---|---|---|---|---|---|---|
| R0 | 14 | 4 | 13 | 1 | 2 | 15 | 11 | 8 | 3 | 10 | 6 | 12 | 5 | 9 | 0 | 7 |
| R1 | 0 | 15 | 7 | 4 | 14 | 2 | 13 | 1 | 10 | 6 | 12 | 11 | 9 | 5 | 3 | 8 |
| R2 | 4 | 1 | 14 | 8 | 13 | 6 | 2 | 11 | 15 | 12 | 9 | 7 | 3 | 10 | 5 | 0 |
| R3 | 15 | 12 | 8 | 2 | 4 | 9 | 1 | 7 | 5 | 11 | 3 | 14 | 10 | 0 | 6 | 13 |

In the table, “R” indicates a row and “C” indicates a column.

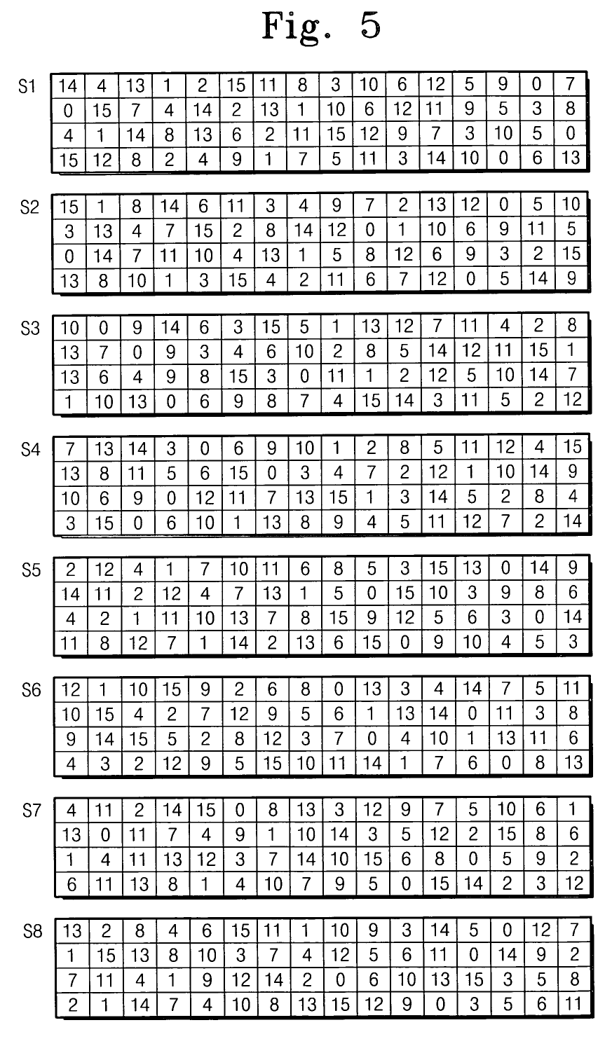

If S1 is the function defined in Table 6 and B is a block of 6 bits, then S1(B) is determined as follows. The first and last bits of B represent, in base 2, a number in the decimal range 0 to 3 (or binary 00 to 11). Let that number be i. The middle 4 bits of B represent in base 2 a number in the decimal range 0 to 15 (binary 0000 to 1111). Let that number be j. The number in the i-th row and j-th column is selected in the table. It is a number in the range 0 to 15 and is uniquely represented by a 4-bit block. That block is the output S1(B) of S1 for the input B. For example, for input block B=011011 the first bit is “0” and the last bit is “1” giving 01 as the row. This is row 1. The middle four bits are “1101 ”. This is the binary equivalent of decimal 13, so the column is column number 13. In row 1, column 13 appears 5. This determines the output; 5 is binary 0101, so that the output is 0101. Hence S1(011011)=0101. The tables defining the functions S2, . . . , S8 are illustrated in FIG. 5. Remaining S boxes convert a 6-bit block into a 4-bit block in the same manner as described above.

For example, for the first round, the following result is obtained as the output of the eight S boxes:

K1+E(R0)=011000 010001 011110 111010 100001 100110 010100 100111

S1(B1)S2(B2)S3(B3)S4(B4)S5(B5)S6(B6)S7(B7)S8(B8)=0101 1100 1000 0010 1011 0101 1001 0111

The determination of f further includes a permutation P of the S-box output to obtain the final value of f:

f=P(S1(B1)S2(B2)S3(B3)S4(B4)S5(B5)S6(B6)S7(B7)S8(B8))

The permutation P is defined in Table 7. P yields a 32-bit output from 32-bit input by permuting the bits of the input block.

TABLE 7

| | | | |
|---|---|---|---|
| 16 | 7 | 20 | 21 |
| 29 | 12 | 28 | 17 |
| 1 | 15 | 23 | 26 |
| 5 | 18 | 31 | 10 |
| 2 | 8 | 24 | 14 |
| 32 | 27 | 3 | 9 |
| 19 | 13 | 30 | 6 |
| 22 | 11 | 4 | 25 |

For example, from the output of the eight S boxes,

S1(B1)S2(B2)S3(B3)S4(B4)S5(B5)S6(B6)S7(B7)S8(B8)=0101 1100 1000 9910 1011 0101 1001 0111

The final value f is obtained:

f=0010 0011 0100 1010 1010 1001 1011 1011

R1=L0+f(R0,K1)

=1100 1100 0000 0000 1100 1100 1111 1111

+0010 0011 0100 1010 1010 1001 1011 1011

=1110 1111 0100 1010 0110 0101 0100 0100

Referring to FIG. 3, in the next round, L2 becomes R1, which is the previously determined block. R2 is determined as R2=L1 +f(R1,K2), and so on for 16 rounds. The blocks L16 and R16 are obtained at the end of sixteenth round. The order of the two blocks is reversed to yield the 64-bit block of R16L16, which is applied to a permutation IP-1 as illustrated by Table 8.

TABLE 8

| | | | | | | | |
|---|---|---|---|---|---|---|---|
| 40 | 8 | 48 | 16 | 56 | 24 | 64 | 32 |
| 39 | 7 | 47 | 15 | 55 | 23 | 63 | 31 |
| 38 | 6 | 46 | 14 | 54 | 22 | 62 | 30 |
| 37 | 5 | 45 | 13 | 53 | 21 | 61 | 29 |
| 36 | 4 | 44 | 12 | 52 | 20 | 60 | 28 |
| 35 | 3 | 43 | 11 | 51 | 19 | 59 | 27 |
| 34 | 2 | 42 | 10 | 50 | 18 | 58 | 26 |
| 33 | 1 | 41 | 9 | 49 | 17 | 57 | 25 |

That is, the output of the algorithm has bit 40 of the preoutput block as its first bit, bit 8 as its second bit, and so on, until bit 25 of the preoutput block is the last bit of the output.

For example, if all 16 blocks are processed using the method defined previously, it is obtained, on the 16^{th} round,

L16=0100 0011 0100 0010 0011 0010 0011 0100

R16=0000 1010 0100 1100 1101 1001 1001 0101

The order of these two blocks is reversed and applied to the final permutation resulting in:

R16L16=00001010 01001100 11011001 10010101 01000011 01000010 00110010 00110100

IP¹=10000101 11101000 00010011 01010100 00001111 00001010 10110100 00000101

which in hexadecimal format is 85E81350FOAB405. This is the encrypted form of D=0123456789ABCDEF: namely, C=85E81350FOAB405. Decryption is simply the inverse of encryption, following the same steps as above, but reversing the order in which the subkeys are applied.

As described above, an encryption device according to the present invention includes two encryption blocks 140 and 160, which perform an enciphering operation according to the manner as described above. In particular, the encryption block 140 utilizes a plaintext D and cipher keys K1-K16 without modification, while the encryption block 160 utilizes a complement plaintext D′ and complement cipher keys K1′-K16′. Since a greater amount of current is consumed when a function f operates, a current consumption pattern caused when processing a ‘0’ bit is different from a current pattern caused when processing a ‘1’ bit. Hence, it is possible to find key values used at ciphering by monitoring (or analyzing) current patterns. In case of the present invention, however, when a function f in each round of the first encryption block 140 processes a ‘0’ bit, a function f in each round of the second encryption block 160 processes a ‘1’ bit. That is, since corresponding functions f of the encryption blocks 140 and 160 process contrary data values to each other, a difference between current patterns caused when processing ‘0’ and ‘1’ bits is substantially reduced. Therefore, it is difficult to find key values using current patterns generated when a data block is enciphered.

The invention has been described using exemplary preferred embodiments. However, it is to be understood that the scope of the invention is not limited to the disclosed embodiment. On the contrary, it is intended to cover various modifications and similar arrangements. The scope of the claims, therefore, should be accorded the broadest interpretation so as to encompass all such modifications and similar arrangements.

What is claimed is:

1. An encryption apparatus comprising:
a first N-round DES device for cryptographically converting a digital input data block into a first digital output data block nonlinearly, based on an input of a set of encryption keys;
a first input means for receiving and inverting the digital input data block;
a second input means for receiving and inverting the set of encryption keys; and
a second N-round DES device for cryptographically converting the inverted digital input data block into a second digital output data block nonlinearly, based on an input of the set of inverted encryption keys,
wherein the first and second N-round DES devices perform a substantially simultaneous cryptographic conversion process.

2. The encryption apparatus according to claim 1, wherein the first and second N-round DES devices perform a cryptographic conversion process according to a DES algorithm, respectively.

3. The encryption apparatus according to claim 1, further comprising means for storing the first and second digital output data blocks from the first and second N-round DES devices, either one of the first and second digital output data blocks being used as an encryption data block.

4. The encryption apparatus according to claim 1, further comprising a third input means for transferring the digital input data block to the first N-round DES device.

5. The encryption apparatus according to claim 1, further comprising an encryption key block for receiving a key and generating the set of encryption keys based on a permutation of the key.

6. The encryption apparatus according to claim 1, further comprising a fourth input means for transferring the set of encryption keys to the first N-round DES device.

7. A method of cryptographically converting digital input data comprising the steps of:
cryptographically converting a digital input data block into a first digital output data block nonlinearly, based on an input of a set of encryption keys;
inverting the digital input data block and the set of encryption keys; and
cryptographically converting the inverted digital input data block into a second digital output data block nonlinearly, based on an input of the inverted encryption keys, wherein the cryptographic conversion processes for obtaining the first and second digital output data blocks are substantially simultaneously performed according to a DES algorithm.

8. The method according to claim 7, wherein either one of the first and second digital output data blocks is used as an encryption data block.

9. An encryption apparatus having a substantially uniform current pattern during cryptographic processes comprising:
a first N-round DES device producing a first current pattern during cryptographic process on a digital input data block, based on an input of a set of encryption keys; and
a second N-round DES device producing a second current pattern during cryptographic process on an inverse of the digital input data block, based on an input of the set of inverted encryption keys,
wherein the first and second N-round DES devices perform a substantially simultaneous cryptographic conversion processes and wherein the first and second current patterns are inverse patterns, respectively.

10. The encryption apparatus according to claim 9, wherein the first and second N-round DES devices perform a cryptographic conversion process according to a DES algorithm, respectively.

11. The encryption apparatus according to claim 9, further comprising means for storing a first and second digital output data blocks from the first and second N-round DES devices, respectively, either one of the first and second digital output data blocks being used as an encryption data block.

12. The encryption apparatus according to claim 9, further comprising a third input means for transferring the digital input data block to the first N-round DES device.

13. The encryption apparatus according to claim 9, further comprising an encryption key block for receiving a key and generating the set of encryption keys based on a permutation of the key.

14. The encryption apparatus according to claim 9, further comprising a fourth input means for transferring the set of encryption keys to the first N-round DES device.
